(19) United States
(12) Patent Application Publication
(10) Pub. No.: US 2026/0255111 A1
(43) Pub. Date: Aug. 27, 2026

(54) HEARING DEVICE WITH MACHINE LEARNING-BASED NOISE CANCELLATION

(71) Applicant: GN Hearing A/S, Ballerup (DK)

(72) Inventors: Ziyue Zhao, Eindhoven (NL); Brian Dam Pedersen, Karlslunde (DK); Erik Cornelis Deiderik Van Der Werf, Eindhoven (NL)

(73) Assignee: GN Hearing A/S, Ballerup (DK)

(21) Appl. No.: 19/651,736

(22) Filed: Apr. 19, 2026

Related U.S. Application Data
(63) Continuation of application No. PCT/EP2024/079571, filed on Oct. 18, 2024.

(30) Foreign Application Priority Data
Oct. 20, 2023 (EP) 23204919

(51) Int. Cl. H04R 25/00; H04R 3/04

(52) U.S. Cl. CPC H04R 25/507; H04R 3/04; H04R 25/40; H04R 2225/43; H04R 2460/01

(57) ABSTRACT

A hearing device includes: an input module for provision of an input signal; a time domain filter configured to perform filtering to provide a filter output signal based on the input signal; a processor configured to provide an electrical output signal based on the filter output signal, the processor configured to compensate for hearing loss of a user of the hearing device; a receiver configured to provide an audio output signal based on the electrical output signal; and a controller comprising a machine learning model for provision of a model output based on the input signal, wherein the controller is configured to: determine a first gain based on the model output; determine a filter control signal based on the first gain; and provide the filter control signal to the time domain filter for filtering the input signal based on the filter control signal.

### RELATED APPLICATION DATA

This application is a continuation of International Patent Application No. PCT/EP2024/079571 filed on Oct. 18, 2024, which claims priority to, and the benefit of, European Patent Application No. 23204919 filed on Oct. 20, 2023. The entire disclosures of the above applications are expressly incorporated by reference herein.

### FIELD

The present disclosure relates to a hearing device and related methods including a method of operating a hearing device.

### BACKGROUND

Hearing instruments, HIs, aim to help end users to improve their hearing experience. However, users may suffer from poor speech quality and low speech intelligibility in some challenging acoustical environments (e.g., cocktail parties and/or crowded stadiums). In such challenging acoustical environments, although beamforming technologies may be able to suppress interfering sources from other directions (e.g., background noise) than a source of interest, strong background noise may still be present in the desired direction.

### SUMMARY

Accordingly, there is a need for hearing devices and methods for suppressing background noise which may mitigate, alleviate or address the shortcomings existing and may provide for improved speech quality and intelligibility in such challenging acoustical environments.

A hearing device is disclosed. The hearing device comprises an input module for provision of an input signal. The input module comprises one or more microphones including a first microphone for provision of a first microphone input signal. The input signal is based on the first microphone input signal. The hearing device comprises a time domain filter for filtering the input signal for provision of a filter output signal. The hearing device comprises a processor for processing the filter output signal and providing an electrical output signal based on the filter output signal. The hearing device comprises a receiver for converting the electrical output signal to an audio output signal. The hearing device comprises a controller comprising a machine learning, ML, model for provision of an ML output based on the input signal. The controller is optionally configured to determine a first gain based on the ML output, and the controller is optionally configured to determine a filter control signal based on the first gain. The controller is configured to provide the filter control signal to the time domain filter for filtering the input signal based on the filter control signal.

Further, a method, such as a computer-implemented method, for training a machine learning model to process as input an ML input based on an input signal and provide as output an ML output indicative of a gain is provided. The method comprises executing, by a computer, multiple training rounds. Each training round of the method comprises determining a training data set comprising a training audio signal and a target audio signal. Each training round of the method comprises applying the training audio signal as input to a controller comprising the machine learning model for provision of an ML output based on the training audio signal. Each training round of the method comprises determining a first gain based on the ML output. Each training round of the method comprises determining a filter control signal based on the first gain. Each training round of the method comprises providing the filter control signal to a time domain filter for filtering the training audio signal based on the filter control signal for provision of a training output signal. Each training round of the method comprises determining an error signal based on the training output signal and the target audio signal. Each training round of the method comprises adjusting weights, using a learning rule, of the machine learning model based on the error signal.

It is an advantage of the present disclosure that, by reducing background noise from a speech signal and/or audio signal, an improved hearing experience is provided in particular in a challenging acoustical environment. Further, the present disclosure provides an ML model capable of cancelling such background noise. In other words, the present disclosure may allow a single-channel noise reduction using a deep neural network which may be integrated in a hearing device, such as a hearing instrument/aid.

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1 schematically illustrates an example hearing device according to the disclosure,

FIGS. 2-3 schematically illustrate example parts of a hearing device according to the disclosure,

FIG. 4 schematically illustrates an example hearing device with a training component according to the disclosure,

FIG. 5 schematically illustrates an example structure of a machine learning model,

FIG. 6 schematically illustrates an example structure of a machine learning model,

FIG. 7 is a flow-chart of an example method for training a machine learning model according to the disclosure, and

FIG. 8 schematically illustrates an example post-processor.

### DETAILED DESCRIPTION

Various example embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user and may be a hearable, a hearing instrument, or a hearing aid, wherein the processor is configured to compensate for a hearing loss of a user.

The hearing device may be of the behind-the-ear (BTE) type, in-the-ear (ITE) type, in-the-canal (ITC) type, receiver-in-canal (RIC) type or receiver-in-the-ear (RITE) type. The hearing aid may be a binaural hearing aid. The hearing device may comprise a first earpiece and a second earpiece, wherein the first earpiece and/or the second earpiece is an earpiece as disclosed herein.

The hearing device may be configured for wireless communication with one or more devices, such as with another hearing device, e.g. as part of a binaural hearing system, and/or with one or more accessory devices, such as a smartphone and/or a smart watch. The hearing device optionally comprises an antenna for converting one or more wireless input signals, e.g. a first wireless input signal and/or a second wireless input signal, to antenna output signal(s). The wireless input signal(s) may origin from external source(s), such as spouse microphone device(s), wireless TV audio transmitter, and/or a distributed microphone array associated with a wireless transmitter. The wireless input signal(s) may origin from another hearing device, e.g. as part of a binaural hearing system, and/or from one or more accessory devices.

The hearing device optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device may comprise a plurality of antennas and/or an antenna may be configured to be operate in one or a plurality of antenna modes. The transceiver input signal optionally comprises a first transceiver input signal representative of the first wireless signal from a first external source.

The hearing device comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more example hearing devices, the number N of microphones is two, three, four, five or more. The set of microphones may comprise a third microphone for provision of a third microphone input signal.

The hearing device optionally comprises a pre-processing unit. The pre-processing unit may be connected to the radio transceiver for pre-processing the transceiver input signal. The pre-processing unit may be connected the first microphone for pre-processing the first microphone input signal. The pre-processing unit may be connected the second microphone if present for pre-processing the second microphone input signal. The pre-processing unit may comprise one or more A/D-converters for converting analog microphone input signal(s) to digital pre-processed microphone input signal(s).

The hearing device comprises a processor for processing input signals, such as pre-processed transceiver input signal and/or pre-processed microphone input signal(s). The processor provides an electrical output signal based on the input signals to the processor. Input terminal(s) of the processor are optionally connected to respective output terminals of the pre-processing unit. For example, a transceiver input terminal of the processor may be connected to a transceiver output terminal of the pre-processing unit. One or more microphone input terminals of the processor may be connected to respective one or more microphone output terminals of the pre-processing unit.

The hearing device comprises a processor for processing input signals, such as pre-processed transceiver input signal(s) and/or pre-processed microphone input signal(s). The processor is optionally configured to compensate for hearing loss of a user of the hearing device. The processor provides an electrical output signal based on the input signals to the processor. Input terminal(s) of the processor are optionally connected to respective output terminals of the pre-processing unit. For example, a transceiver input terminal of the processor may be connected to a transceiver output terminal of the pre-processing unit. One or more microphone input terminals of the processor may be connected to respective one or more microphone output terminals of the pre-processing unit.

It is noted that descriptions and features of hearing device functionality, such as hearing device configured to, also apply to methods and vice versa. For example, a description of a hearing device configured to determine also applies to a method, e.g. of operating a hearing device, wherein the method comprises determining and vice versa.

The hearing device comprises an input module for provision of an input signal. The input module comprises one or more microphones including a first microphone for provision of a first microphone input signal. The input signal is based on the first microphone input signal. In one or more examples, the input signal can be seen as a representation of a sound (e.g., a speech waveform).

The hearing device comprises a time domain filter for filtering the input signal for provision of a filter output signal.

The hearing device comprises a processor for processing the filter output signal and providing an electrical output signal based on the filter output signal.

The hearing device comprises a receiver for converting the electrical output signal to an audio output signal.

The hearing device comprises a controller optionally implemented in the processor. The controller optionally comprises a machine learning model for provision of an ML output based on the input signal. The controller is configured to determine a first gain, e.g. based on the ML output. The controller is configured to determine a filter control signal based on the first gain. The controller is configured to provide the filter control signal to the time domain filter for filtering the input signal based on the filter control signal.

In one or more example hearing devices, the hearing device comprises an input module for provision of an input signal, the input module comprising one or more microphones including a first microphone for provision of a first microphone input signal, wherein the input signal is based on the first microphone input signal; a time domain filter for filtering the input signal for provision of a filter output signal; a processor for processing the filter output signal and providing an electrical output signal based on the filter output signal; and a receiver for converting the electrical output signal to an audio output signal, wherein the hearing device comprises a controller comprising a machine learning model for provision of an ML output based on the input signal, wherein the controller is configured to: determine a first gain based on the ML output; determine a filter control signal based on the first gain; and provide the filter control signal to the time domain filter for filtering the input signal based on the filter control signal.

In one or more example hearing devices, the time domain filter comprises a warped finite impulse response, FIR, filter. In one or more examples, a Warped FIR filter comprises one or more of: a warp delay line and a FIR filter. The warp delay line may comprise one or more first order all-pass, AP, filters (e.g., filters with a unity gain across all frequencies). A first order AP filter may be associated with a first order all pass response, such as AP=(z⁻¹−a)/(1−az⁻¹). Optionally, the time domain filter can be a FIR filter (e.g., AP=z⁻¹).

In one or more example hearing devices, the controller comprises a post-processor for processing the ML output. In one or more example hearing devices, the post-processor comprises one or more of a limiter and a smoother. In one or more examples, the limiter is configured to limit the ML output based on a first threshold or first upper bound. In one or more examples, the limiter is configured to control (e.g., limit) the ML output by determining whether the ML output exceeds the first threshold/upper bound. In one or more examples, the limiter is configured to, upon determining that the ML output exceeds the first threshold, limiting the ML output to the first threshold. In one or more examples, the limiter is configured to, upon not determining that the ML output exceeds the first threshold, not limiting the ML output to the first threshold. In one or more examples, the limiter may allow preventing any increase in the level of the ML output above the first threshold. In one or more examples, the limiter is a gain limiter when the ML output is a gain (e.g., the first gain).

The limiter may be a gain limiter. The limiter may be configured to apply one or more gain limit profiles, e.g. to the ML output or to a gain booster output as described below. The limiter may be configured to apply a gain limit profile, e.g. selected from a plurality of gain limit profiles, e.g. a first gain limit profile, a second gain limit profile and optionally a third gain limit profile. The limiter may select a gain limit profile in accordance with a control signal from processor or a setting in the memory.

The limiter may be configured to apply a first gain limit profile, e.g. in accordance with a first control signal from processor or a first setting in the memory. The limiter may be configured to apply a second gain limit profile, e.g. in accordance with a second control signal from processor or a second setting in the memory. The limiter may be configured to apply a third gain limit profile, e.g. in accordance with a third control signal from processor or a third setting in the memory. Thus, the limiter may advantageously control the level or aggressiveness of the noise reduction. In other words, the limiter may control how much noise is reduced.

The first gain profile may have a first upper bound. The first upper bound may be the same for all bands/channels. The first upper bound may be band-specific. In one or more examples, the first upper bound may be 0 dB for all bands or for a subset of bands.

The first gain profile may have a first lower bound. The first lower bound may be the same for all bands/channels. The first lower bound may be band-specific. In one or more examples, the first lower bound may be one value, e.g. in the range from −4 to −10 dB, such as −6 dB, for all bands. In one or more examples, the first lower bound may be one value for some bands and another value for other bands. In other words, to apply a first gain limit profile may comprise to set a gain output to the first upper bound if the gain input is larger than the first upper bound and/or to set a gain output to the first lower bound if the gain input is less than the first lower bound.

The second gain profile may have a second upper bound. The second upper bound may be the same for all bands/channels. The second upper bound may be band-specific. In one or more examples, the second upper bound may be 0 dB for all bands or for a subset of bands.

The second gain profile may have a second lower bound. The second lower bound may be the same for all bands/channels. The second lower bound may be band-specific. In one or more examples, the second lower bound may be one value, e.g. in the range from −6 to −12 dB, such as −6 dB or −9 dB, for all bands. In one or more examples, the second lower bound may be one value, e.g. in the range from −4 dB to −10 dB, such as −6 dB, for some bands, such as for N bands (N optionally in the range from 3 to 10) below a frequency threshold, and another value, e.g. in the range from −8 dB to −14 dB, such as −12 dB, for other bands, such as for M bands (M optionally in the range from 6 to 18) above a frequency threshold. In other words, to apply a second gain limit profile may comprise to set a gain output to the second upper bound if the gain input is larger than the second upper bound and/or to set a gain output to the second lower bound if the gain input is less than the second lower bound.

The third gain profile may have a third upper bound. The third upper bound may be the same for all bands/channels. The third upper bound may be band-specific. In one or more examples, the third upper bound may be 0 dB for all bands or for a subset of bands.

The third gain profile may have a third lower bound. The third lower bound may be the same for all bands/channels. The third lower bound may be band-specific. In one or more examples, the third lower bound may be one value, e.g. in the range from −9 dB to −18 dB, such as −9 dB, −12 dB or −15 dB, for all bands. In one or more examples, the third lower bound may be one value, e.g. in the range from −6 dB to −12 dB, such as −9 dB, for some bands, such as for N bands (N optionally in the range from 3 to 10) below a frequency threshold, and another value, e.g. in the range from −12 dB to −18 dB, such as −15 dB, for other bands, such as for M bands (M optionally in the range from 6 to 18) above a frequency threshold. In other words, to apply a third gain limit profile may comprise to set a gain output to the third upper bound if the gain input is larger than the third upper bound and/or to set a gain output to the third lower bound if the gain input is less than the third lower bound.

The post-processor may comprise a booster, such as a gain booster, e.g. for receiving the ML output, e.g. a gain, as booster input and provision of a booster output based on the ML output. In one or more examples, the booster may apply or add gain(s) to the ML output, such as to one or more bands/channels of the ML output. The booster may apply the same gain, such as in the range from 1 dB to 6 db, e.g. 3 dB, or band-specific gains to the ML-output. The booster may be arranged before the limiter in the post-processor, e.g. between the machine learning model and the limiter. The booster in the post-processing can restore potential speech distortions caused by the ML noise reduction and thus maintain the signal level, such as speech.

In one or more examples, the smoother has a smoother input and a smoother output and may be configured to smooth the smoother input, e.g. ML output, booster output, or limiter output, e.g. based on one or more second thresholds. In other words, the smoother is configured to control (e.g., smooth) one or more intensity fluctuations associated with the ML output/smoother input by determining whether the one or more intensity fluctuations associated with the ML output or smoother input exceeds the one or more second thresholds. The one or more intensity fluctuations may indicate one or more of a peak and a valley of a waveform (e.g., a frequency response) associated with the ML output/smoother input. In one or more examples, the smoother is configured to, upon determining that an intensity fluctuation exceeds a respective second threshold, smoothing such part of the ML output/smoother input based on the respective second threshold. In one or more examples, the smoother is configured to, upon not determining that an intensity fluctuation exceeds a respective second threshold, not smoothing the ML output/smoother input. Thus, the smoother reduces the fluctuation of the gains for noise reduction, and thus mitigates the artifacts which are generated due to the fast changing of the gains, which in turn may allow for a more robust noise reduction.

Thus, to determine the first gain may comprise post-processing the ML output for provision of a post-processor output. The post-processor output may be or form the first gain.

In one or more example hearing devices, the input module comprises a beamformer for provision of a beamformer output. In one or more example hearing devices, the input signal is based on the beamformer output. The beamformer output may form or constitute the input signal.

In one or more example hearing devices, the controller is configured to determine one or more features including a first feature based on the input signal. In one or more examples, the controller is configured to perform feature extraction. In other words, the controller may be configured to determine one or more features from the input signal. A feature may be one or more of: a power, pitch, and a vocal tract configuration. In one or more example hearing devices, the ML output is based on the first feature. In one or more examples, the controller comprises a feature extraction function configured to determine one or more features from the input signal.

In one or more example hearing devices, the controller is configured to apply a window function to the input signal for provision of a window signal.

In one or more example hearing devices, the controller is configured to apply a fast Fourier transform, FFT, function to the window signal for provision of an FFT signal. In other words, the controller may convert the window signal from a time domain into a frequency domain. The FFT signal may be seen as a spectral representation of the window signal.

In one or more example hearing devices, the controller is configured to determine the ML output by applying the machine learning, ML, model to the first feature. In one or more examples, the first feature is a ML input to the ML model.

In one or more example hearing devices, the first feature comprises a power output. In other words, the first feature may be seen as a short time log-power spectrum (such as, a power per frequency band) associated with the input signal. In one or more examples, the controller is configured to extract the short time log-power spectrum from the FFT signal.

In one or more examples, the controller is configured to determine the power output by taking a snapshot of the input signal every M samples. In other words, the power output may be a signal which is sampled at a sampling rate M. The ML model may provide an ML output for each frequency band associated with the time-domain filter. In other words, the ML model may predict and/or estimate the first gain for each Warp band at every block (e.g., a block resulting from the sampling procedure). In one or more examples, when M is less than one block, a low pass-filtering procedure and a down-sampling to the block rate may be applied to the power output.

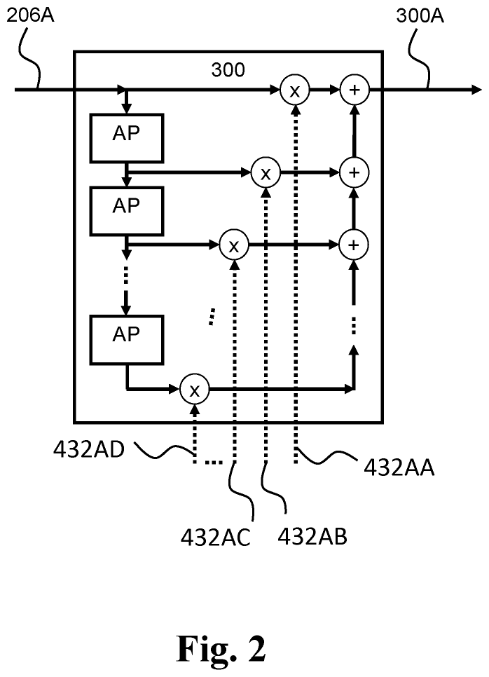

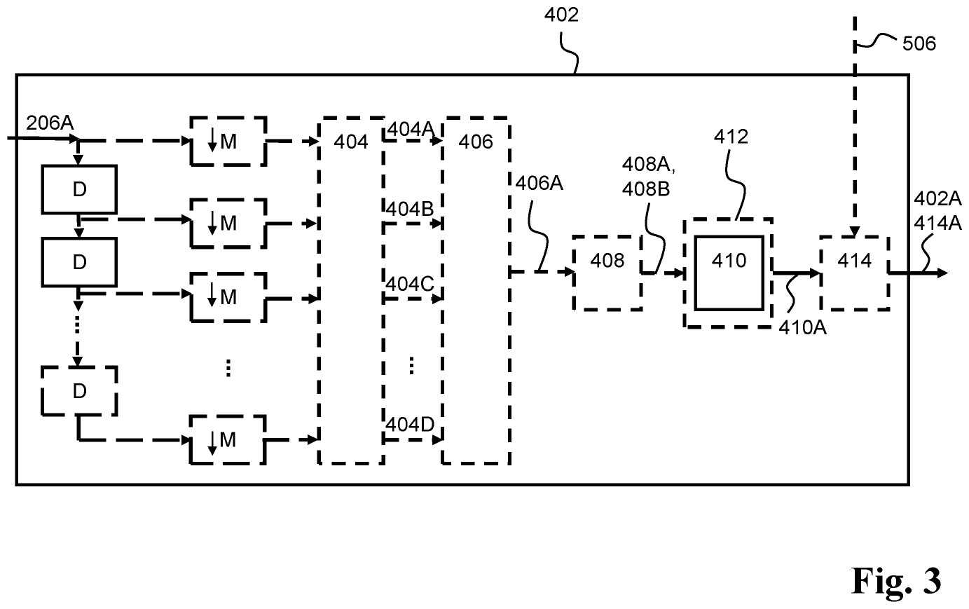

In one or more examples, the controller is configured to determine the power output on a warped frequency scale. In other words, the power output may be determined based on the warped delay of the time domain filter (e.g., the frequency warping of the first order AP filters), e.g. D=AP (see FIGS. 2 and 3). Optionally, the power output can be determined based on another frequency scale, such as a predicted frequency scale. The ML model may be able to learn a mapping between one or more frequency scales for provision of the power output.

Optionally, the controller is configured to determine the power output based on a linear delay line (D=z⁻¹). This may avoid the need for additional AP filter operations in a delay line that is integrated in the controller. To compensate a loss in frequency resolution at low frequencies, and increase smoothness, the delay line and corresponding FFT size may be extended to cover more than one input block. Optionally, the AP operations of the Warped FIR filter can be re-used by the controller. This may require either a temporary storage of a relatively large matrix of intermediate states or delaying the application of the filter control signal by at least one (additional) block.

In one or more example hearing devices, the machine learning model comprises a deep neural network, DNN. In one or more examples, the deep neural network can be a recurrent neural network, RNN. The machine learning model may be a trained machine learning model.

The present disclosure may provide a ML-based noise cancellation technique in which a gain agent (e.g., and/or a combine gain as result of one or more gain agents) is integrated in the time domain filter. The present disclosure may avoid increased processing delay in a main audio path. The main audio path may include one or more of: the input module, the time domain filter, and the receiver. The present disclosure may enable the ML model to be used as a plug-in replacement of a traditional single channel noise reduction techniques, e.g. passive noise reduction, PNR, technique.

In one or more example hearing devices, the ML output is one or more of: a gain (e.g., the first gain), a signal-to-noise ratio, SNR, voice activity detection, VAD, data, speaker recognition data, and a speech-to-signal mixture ratio. In one or more examples, VAD data may be seen as data indicative of presence and/or absence of human speech in the input signal (e.g., acoustic signal). For example, VAD data can be seen as speech activity data. In one or more examples, a SNR is indicative of a ratio of a signal power (e.g., a speech signal) to a noise power (e.g., a background noise present in a speech signal).

In one or more examples, the ML output is a gain, e.g. a vector comprising band-specific gains.

In one or more example hearing devices, the controller comprises a converter for converting the ML output to a gain (e.g., the first gain). In one or more examples, a first gain determiner may comprise one or more of: the delay line, the sampling rate line, the window function, the FFT function, the feature extraction function, the ML model, the post processor, and optionally the converter. In one or more examples, the first gain determiner is configured to determine the gain, e.g. the first gain.

In one or more example hearing devices, the controller comprises a combiner for combining the first gain with a second gain for provision of a combined gain. In one or more examples, the second gain can be related with one or more of: a wind noise, an impulse noise, an expansion, a maximum power output, MPO, and any other suitable feature. In one or more examples, the second gain can be an automatic gain control, AGC. In one or more examples, the controller comprises a second gain determiner for determining the second gain. The second gain determiner may comprise one or more of: a second delay line, a second sampling rate line, a second window function, a second FFT function, a second feature extraction function, and a post processor. In one or more examples, combining the first gain with the second gain comprises performing one or more arithmetic operations to the first gain and second gain (e.g., multiplication, division, addition and/or subtraction). For example, combining the first gain with the second gain comprises adding the first gain to the second gain. In one or more examples, the first gain can be combined with the second gain for dynamic range compression. In one or more example hearing devices, to determine the filter control signal based on the first gain comprises to determine the filter control signal based on the combined gain.

In one or more example hearing devices, to determine the filter control signal based on the first gain comprises to determine filter coefficients of the time domain filter. The time domain filter may be a warped FIR filter. In one or more example hearing devices, to determine a filter control signal based on the first gain comprises to include the filter coefficients in the first control signal. In other words, the filter coefficients may be applied to the time domain filter (e.g., a warped FIR filter). The filter coefficients may be used to update the time-domain filter.

In one or more example hearing devices, the input module comprises a transceiver for provision of a transceiver input signal. In one or more example hearing devices, the input signal is based on the transceiver input signal. In one or more examples, the transceiver input signal is received from a contralateral hearing device.

Further, the present disclosure relates to a computer-implemented method for training a machine learning, ML, model. The ML model is configured to process as input an ML input based on an input signal. The ML model is configured to provide as output an ML output indicative of a gain (e.g., the first gain). The ML input may be a power output, e.g. a short time log-power spectrum. Optionally, the ML input is one or more of: a window signal, an FFT signal (e.g., a spectral representation of a window signal), and the input signal. The method comprises executing, by a computer, multiple training rounds.

Each training round of the method comprises determining a training data set comprising a training audio signal and a target audio signal. In one or more examples, the ML model may be trained with the training data set. In one or more examples, the training audio signal may include the ML input. The target audio signal may be a desired (e.g., expected) clean speech signal.

Each training round of the method comprises applying the training audio signal as input to a controller comprising the machine learning model for provision of an ML output based on the training audio signal. In one or more examples, the ML output may converge to the target audio signal by performing each training round of the method. The ML output may be similar (e.g., approximately equal) to the target audio signal after performing a number of training rounds of the method.

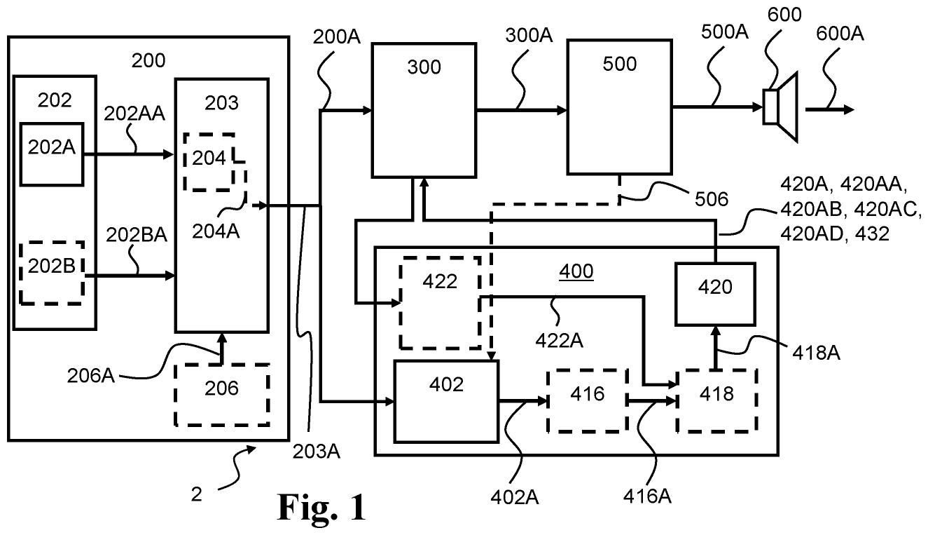

Each training round of the method comprises determining a first gain based on the ML output. The ML output may be the first gain. Optionally, the ML output can be indicative of one or more of: a signal-to-noise ratio (SNR), a signal-and-noise-to-noise ratio (XNR), voice activity detection (VAD), data, speaker recognition data, and a speech-to-signal mixture ratio. Such ML output may be converted into a gain by a converter, such as converter 416 of hearing device 2 of FIG. 1. In one or more examples, the ML output is not a combined gain, e.g. a gain combined with one or more gains (e.g., a second gain of one or more gain agents). In one or more examples, the first gain may be seen as a predicted gain.

Each training round of the method comprises determining a filter control signal based on the first gain.

Each training round of the method comprises providing the filter control signal to a time domain filter for filtering the training audio signal based on the filter control signal for provision of a training output signal. In one or more examples, determining the filter control signal based on the first gain comprises determining filter coefficients associated with the time domain filter. In one or more examples, determining the filter control signal comprises including in the filter control signal. In one or more examples, providing the filter control signal to the time domain filter comprises applying the filter coefficients to the time domain filter. In other words, the first gain may be integrated in the time domain filter by applying the filter coefficients to the same filter. In one or more examples, the time domain filter is one or more of: a Warped FIR filter and a FIR filter (e.g., AP=z⁻¹).

Optionally, each training round of the method comprises applying the filter coefficients to a frequency domain filter. For example, the time domain filter can be converted into a frequency domain filter using an FFT function.

In one or more examples, the DNN gains may also be applied in the complex frequency domain by providing the network with the complex values in the frequency domain. The enhanced waveform may then be obtained by inverse FFT and (windowed) overlap-add or overlap-save.

In one or more examples of the training method, a gain, such as the first gain, may be used as a target. In other words, each training round may comprise determining a training data set comprising a training audio signal and a target gain; applying the training audio signal as input to a controller comprising the machine learning model for provision of an ML output based on the training audio signal; determining a first gain based on the ML output for provision of a training output signal; determining an error signal based on the training output signal and the target gain; and adjusting weights, using a learning rule, of the machine learning model based on the error signal.

There may be a delay between the ML input and the application of the filter coefficients to the time domain filter. In one or more examples, such delay can be handled while training the ML model. The delay may occur due to one or more of: implementation issues (e.g., hardware and/or software issues) related the update of the time domain filter with the filter coefficients, a communication delay with one or more co-processors, and execution time of the ML model.

Each training round of the method may comprise aligning the training audio signal with the target audio signal. For example, aligning the training audio signal with the target audio signal can be seen as delaying the training audio signal by a required number of blocks to match structure (e.g., behavior) of the target audio signal. The ML model may provide the ML output based on such alignment. In other words, the first gain may be determined (e.g., predicted) one or more blocks ahead, which may avoid the need to add delay in a main audio path, e.g. to include one or more delay lines in the time domain filter.

Each training round of the method comprises determining an error signal (e.g., training error signal) based on the training output signal and the target audio signal. A training round, such as each training round may comprise a normalization before or prior to determining an error signal. In one or more examples, the method can comprise defining a loss function (e.g., cost function) based on the training output signal and the target audio signal for provision of the error signal. In one or more examples, the loss function of the ML model (e.g., a DNN) can quantify a difference between the training audio signal (e.g., ML output predicted by the ML model) and the target audio signal (e.g., an expected ML output). In other words, a loss function measures how well the ML model models the training data set. In one or more examples, the error signal is indicative of a training loss associated with the ML model. Minimisation of such training loss (e.g., reducing the error signal) may be indicative of an improved prediction of the ML output.

In one or more examples, a loss function can be one or more of: a mean squared error, MSE, a negative signal-to-distortion ratio, SDR, a short-time Fourier transform, STFT, and any other suitable loss functions.

In one or more examples, determining the error signal comprises determining a mean squared error, MSE, between the training audio signal and the target audio signal. In one or more examples, determining the error signal comprises determining a negative signal-to-distortion ratio, SDR, between the training audio signal and the target audio signal.

In one or more examples, determining the error signal comprises determining a short-time Fourier transform, STFT, associated with the training audio signal for provision of a first STFT signal. In one or more examples, determining the error signal comprises determining a short-time Fourier transform, STFT, associated with the target audio signal for provision of a second STFT signal. In one or more examples, determining the error signal comprises determining a MSE between the first STFT signal and the second STFT signal. In one or more examples, the first and second STFT signals may be determined in an arbitrary time-frequency resolution (e.g., to have finer resolution than an audio path between the input signal and the audio output signal). It may be envisioned that the error signal is determined for each data batch, with each data batch being associated with a signal longer than one block.

In one or more examples, a short-time Fourier transform (STFT)-based loss function can be used: Compute the STFT in an arbitrary time-frequency resolution (preferably to have finer resolution than the audio path) for both enhanced signal and clean target signal. This is possible since the loss is computed for each data batch, which contains much longer signal compared to one block.

Each training round of the method comprises adjusting (e.g., updating) weights, e.g. using a learning rule, of the machine learning model based on the error signal. In other words, each training round of the method may comprise training the ML model based on the error signal, e.g. by using a learning rule to adjust weights of the ML model based on the error signal. In one or more examples, adjusting the weights of the ML model comprises minimising the training loss associated with the error signal. In other words, adjusting the weights of the ML model may lead to a successful convergence of the ML output to the target audio signal. The ML output may become as close as possible to the target audio signal for the multiple training rounds. The adjusted weights of the ML model may be stored in a ML model module, such as ML model module 412 of hearing device 2 of FIG. 1.

In one or more example methods, the method comprises obtaining an input signal. In one or more examples, the input signal is based on a first microphone input signal.

In one or more example methods, determining the training data set comprises generating the target audio signal by applying a time-domain filter to the input signal. In one or more examples, the time-domain filter is a time-domain filter with a unity gain. In other words, the target audio signal may be generated in such a way that a desired clean speech signal (e.g., without noise) is filtered by the time-domain filter (e.g., a Warped FIR filter) without applying any gain.

In one or more example methods, determining a training data set comprises generating the training audio signal based on the input signal and a noise sound signal. In one or more examples, a noise sound signal may be seen as a signal corrupted by one or more of: a Gaussian noise, an impulse noise, and any other suitable type of noise. For example, a noise sound signal can be a signal corrupted by a random and/or predetermined-valued impulse noise. In other words, a noise sound signal may indicate an ambient noise sound and/or a background noise sound. In one or more examples, the training audio signal is the input signal corrupted by the noise sound signal.

The present disclosure may provide a ML inference method for post-processing the ML output. A training stage may be followed by an inference stage. In other words, the method for training the machine learning model may be followed by the ML inference method. After the training stage, the weights of the ML model may be fixed. In the inference stage, the ML model may be trained (e.g., the weights may be fixed) and ready to be deployed.

The ML inference method may comprise generating an inferred ML output by applying the ML model to an inference data set. Put differently, the ML inference method may generate the inferred ML output based on the trained ML model. The inference data set may be associated with a new input signal (e.g., different from the input signal used for training the ML model). The inferred ML output may be indicative of an inferred gain. The inferred ML output may comprise one or more inferred gains.

In one or more examples, the target audio signal is a clean speech signal. The ML model may be trained to provide an ML output (e.g., the first gain) which can make the training output signal (e.g., spectrum of the training output signal) to be as close as to the target audio signal (e.g., spectrum of the training output signal). During such training stage, the ML model may introduce artifacts, e.g. be perceived as notably aggressive.

The ML inference method may comprise controlling the one or more gains for preventing noise reduction aggressiveness associated with the ML model. In one or more examples, the ML inference method comprises controlling the one or more gains by applying a weighting parameter to the one or more gains for provision of the inferred ML output. The inferred ML output may be given by G=α·G_{ML}+(1−α), where G denotes the inferred (e.g., post-processed) gain, G_{ML} denotes the ML output, and a denotes the weighting factor. The weighting parameter may be a user parameter.

Optionally, the ML inference method comprises controlling the one or more gains based on a gain threshold (e.g., a minimum gain limit), such as Gₘᵢₙ, for provision of the inferred ML output. In other words, the gain threshold may ensure that no gain of the one or more gains is lower than such gain threshold in order to prevent over-attenuation. The inferred ML output may be given by G=max(Gₘᵢₙ, G_{ML}). The gain threshold may be a user parameter.

FIG. 1 schematically illustrates an example hearing device 2 according to the disclosure.

The hearing device 2 comprises an input module 200 for provision of an input signal 200A. The input module 200 comprises one or more microphones 202 including a first microphone 202A for provision of a first microphone input signal 202AA. The input module 200 optionally comprises a second microphone 202B for provision of a second microphone input signal 202BA. The input signal 200A is based on the first microphone input signal 202AA and optionally the second microphone input signal. The input module optionally comprises an input combiner 203 configured to combine e.g. first and second microphone input signals 202AA and 202BA to input signal 200A. The input combiner 203 provides input combiner output signal 203A optionally forming input signal 200A. The input combiner 203 optionally comprises a beamformer 204 for provision of a beamformer output 204A, e.g. based on the first microphone input signal 202AA and the second microphone input signal 202BA. The input signal 200A may be based on the beamformer output 204A. The input module 200 may comprise a transceiver 206 for provision of a transceiver input signal 206A. The input signal 200A may be based on the transceiver input signal 206A, e.g. via input combiner 203. The hearing device 2 comprises a time domain filter 300 for filtering the input signal 200A for provision of a filter output signal 300A. The hearing device 2 comprises a processor 500 for processing the filter output signal 300A and providing an electrical output signal 500A based on the filter output signal 300A. The hearing device 2 comprises a receiver 600 for converting the electrical output signal 500A to an audio output signal 600A.

A main audio path may comprise one or more of: the input module 200, the time domain filter 300, the processor 500, and the receiver 600.

The hearing device 2 comprises a controller 400. The controller 400 is configured to provide a filter control signal 432A to the time domain filter 300 for filtering the input signal 200A for provision of the filter output signal 300A. The controller 400 comprises an analysis side branch block 402, with the analysis side branch block 402 including a trained ML model, for provision of a post-processed ML output also denoted post-processor output 414A, such as a gain 402A (e.g., a first gain). The controller 400 may comprise a converter 416 for provision of a converted ML output 416A. The converter 416 may be configured to convert an ML output to a gain. The controller 400 may comprise a second gain determiner 422 for provision of a second gain 422A. For example, the second gain determiner 422 may be seen as an analysis side branch block but not including a ML model, e.g. analysis side branch block 402 not including the trained ML model. The controller 400 may comprise a combiner 418 for provision of a combined gain 418A. The combiner 418 may be configured to combine the gain 402A, e.g. a first gain, with the second gain 422A, e.g. a second gain for provision of a combined gain 418A. The controller 400 may be configured to determine the filter control signal 420A based on the combined gain 418A. The filter control signal 420A may comprise filter coefficients, e.g. a first filter coefficient 420AA, a second filter coefficient 420AB, a third filter coefficient 420AC for the time domain filter 300. In other words, the filter design 420 may be configured to determine the filter coefficients. The filter coefficients may be applied by the controller 400 to the time-domain filter 300.

FIGS. 2-3 schematically illustrate example parts 300, 402 of a hearing device 2 according to the disclosure. FIG. 2 schematically illustrates a time domain filter 300 of the hearing device 2. The time domain filter 300 may comprise a warped FIR filter. The time-domain filter 300 may comprise one or more first order AP filters, which may be associated with a first order AP response (e.g., AP=(z⁻¹−a)/(1−az⁻¹)). The one or more first order AP filters may be seen a warped delay line. A plurality of filter coefficients, e.g. a first filter coefficient 432AA, a second filter coefficient 432AB, a third filter coefficient 432AC, a fourth filter coefficient 432AD, may be provided to the time domain filter 300 by a controller (e.g., controller 400 of FIG. 1).

FIG. 3 schematically illustrates an analysis side branch block 402 of the hearing device 2. The controller (e.g., controller 400 of FIG. 1) comprises the analysis side branch block 402. The analysis side branch block 402 may comprise one or more of: a delay line D and a sampling rate line M, a window function 404, and an FFT function 406. The analysis side branch block 402 may comprise a feature extraction block 408 for provision of one or more features 408A. The one or more features 408A may include a first feature 408B, e.g. a power output. For example, the power output can be determined based on the delay line D. The delay line D may be a warped delay line (e.g., first order AP filters) and/or a linear delay line. For example, the power output can be determined by sampling a delayed version of the transceiver input signal 206A at a sampling rate M for provision of a sampled signal. The sampled signal may be seen as one or more blocks of M samples each. The window function 404 may be applied to the sampled signal for provision of one or more blocks of a windowed signal 404A, 404B, 404C, 404D. The FFT function 406 may be applied to the one or more blocks of the windowed signal 404A, 404B, 404C, 404D for provision of an FFT signal 406A. The feature extraction block 408 may be configured to extract the power output, e.g. a power per frequency band, from the FFT signal 406A.

The analysis side branch block 402 may comprise a ML model 410, such as a trained ML model for cancelling noise from the transceiver input signal 206A. The ML model 410 may take as input the first feature 408B. The ML model 410 may provide an ML output 410A. The ML output can be one or more of: a gain (e.g., a first gain), an SNR, VAD data, speaker recognition data, and a speech-to-signal mixture ratio. The ML model may be part of a ML model module 412. The machine learning module may be configured to store weights in order to train the ML model. The analysis side branch block 402 may comprise a converter 416 for converting a ML output 410A to a gain 402A, e.g., the first gain. For example, the analysis side branch block 402 can be seen as a first gain determiner configured to determine the gain 402A, e.g. the first gain.

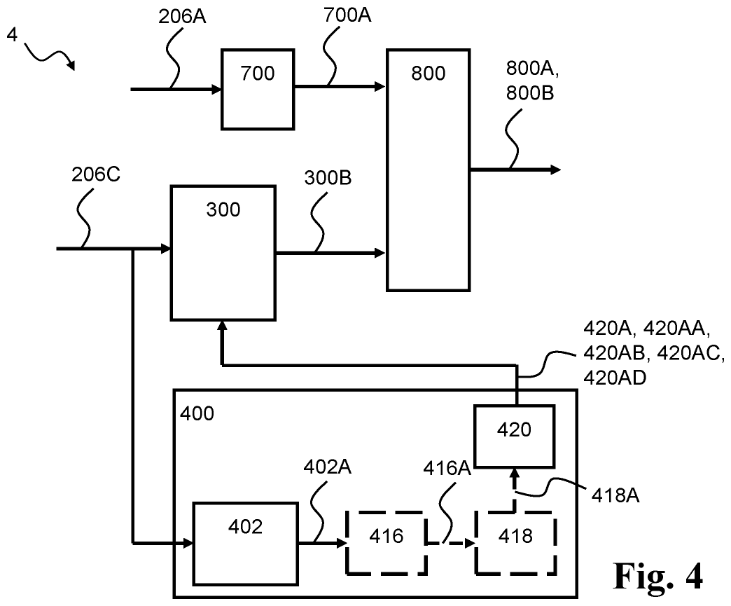

FIG. 4 schematically illustrates an example hearing device with a training component 4 according to the disclosure. The hearing device may be seen as hearing device 2 of FIG. 1 in a training stage of a ML model. In one or more examples, the hearing device comprises a ML model (such as, ML model 410 of FIG. 3) included in an analysis side branch block 402 to be trained based on a training data set. The training data set comprises a training audio signal 206C and a target audio signal 700A. The training audio signal 206C may be generated by applying a noise sound signal (e.g., a noise component) to an input signal (e.g., transceiver input signal 206A).

The hearing device comprises a first time-domain filter 700, e.g. with a unity gain, for filtering the transceiver input signal 206A for provision of a target audio signal 700A. The hearing device comprises a time domain filter 300, e.g. a Warped FIR filter, for filtering the training audio signal for provision of a training output signal 300B. A filter control signal 420A which may comprise filter coefficients, e.g. a first filter coefficient 420AA, a second filter coefficient 420AB, a third filter coefficient 420AC, may be applied by a controller 400 to the time-domain filter 300. The hearing device comprises an error function 800 (e.g., training loss function) for determining an error signal 800A. The error signal 800A may be indicative of a training loss associated with the ML model. The ML model is trained by adjusting weights 800B, e.g. using a learning rule, of the machine learning model based on the error signal 800A.

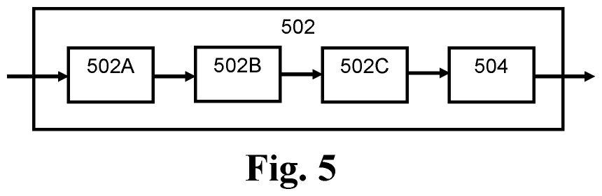

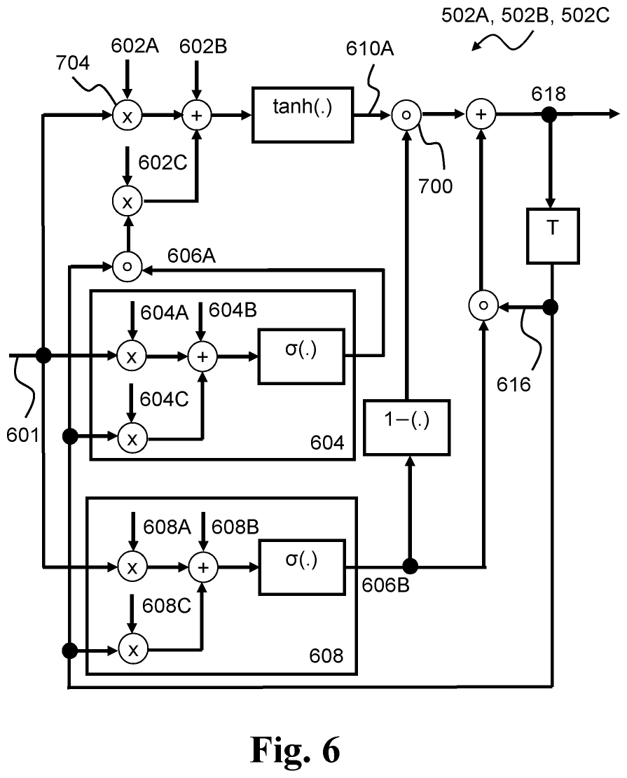

FIGS. 5-6 schematically illustrate an example structure 502 of a machine learning model according to the disclosure, such as ML model 410. In one or more examples, the ML model may comprise a DNN. FIG. 5 schematically illustrates a structure of a DNN. The DNN may be a recurrent neural network, RNN.

The RNN may comprise one or more consecutive gated recurrent units, GRUs, 502A, 502B, 502C followed by a fully connected layer 504 (e.g., a dense layer) with a sigmoid activation function as a final layer. A fully connected layer may be seen as a layer that is used in a final stage of a machine learning model (e.g., a neural network). Each of the one or more GRUs 502A, 502B, 502C may be followed by a dropout layer during a training stage for preventing an overfitting problem associated with the machine learning model. The dropout layer of each of the one or more GRUs 502A, 502B, 502C may be removed in an inference stage.

In one or more examples, the machine learning model can comprise one or more layers before, for example, first GRU 502A. In one or more examples, the machine learning model can comprise one or more layers between two arbitrary GRUs. In one or more examples, the machine learning model can comprise one or more layers before or after the dense and/or fully connected layer 504. The layer may be one or more of: a convolutional layer, a long short-term memory, LSTM, layer, and a convolutional LSTM layer. The number of GRUs of the machine learning model may be reduced and/or enlarged.

FIG. 6 schematically illustrates example internal computations of a GRU (such as, first, second and third GRUs 502A, 502B, 502C of FIG. 5).

A GRU may comprise a reset gate 604 and an update gate 608 for controlling the information flow and learns to capture the time dependencies during the training.

An output of reset gate 606A (such as, r(t)) and an output of update gate 606B (such as, u(t)) may be determined based on a current input 601 (such as, x(t)) and previous hidden state 616 (such as, h(t−1)). The output of reset gate 606A (such as, r(t)) and an output of update gate 606B (such as, u(t)) may contribute to current hidden state 618 (such as, h(t)). The current hidden state 618 (such as, h(t)) may be seen an output of the GRU.

For example, the GRU is a recurrent processing unit, e.g. the previous input can influence the current output under the gating mechanism. The GRU may be associated with trainable parameters. The trainable parameters may be one or more of: a weight matrix for input-hidden mapping (e.g., W^{ih}), a weight matrix for hidden-hidden mapping (e.g., W^{hh}), and a bias (e.g., b). The reset gate 604 may be associated with one or more of: a weight matrix 604A (e.g.,

$${W}_{r}^{i h} ) ,$$

a weight matrix 604C (e.g.,

$${W}_{r}^{i h} ) ,$$

and a bias 604B (e.g., bᵣ). The update gate 608 may be associated with one or more of: a weight matrix 608A (e.g.,

$${W}_{u}^{i h} ) ,$$

a weight matrix 604C (e.g.,

$${W}_{u}^{i h} ) ,$$

and a bias 608B (e.g., bᵤ). A candidate hidden state 610A (such as, \tilde{h}(t)) may be determined based on a weight matrix 602A (e.g.,

$${W}_{o}^{i h} ) ,$$

a weight matrix 602C (e.g.,

$${W}_{o}^{i h} ) ,$$

and a bias 602B (e.g., bₒ).

The internal computations of the GRU may include one or more of: a matrix multiplication, an element-wise multiplication 704, a hyperbolic tangent function (such as, tanh(.)), a sigmoid function (such as, σ(.)).

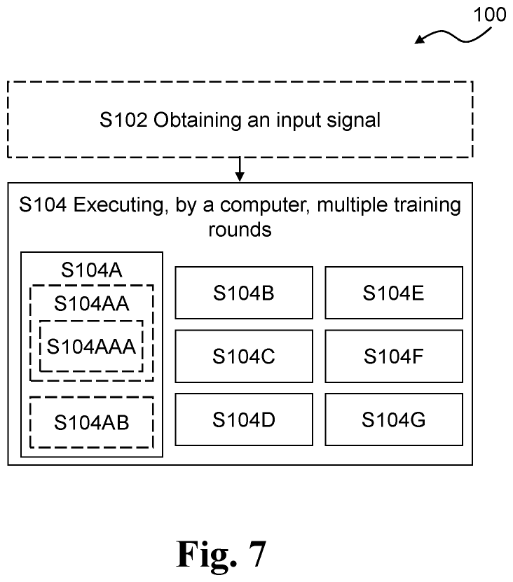

FIG. 7 is a flow-chart of an example method 100 for training a machine learning model according to the disclosure. The method 100 is a computer-implemented method for training a ML model, such as an RNN, of a hearing device (e.g., hearing device 2), to process as input an ML input based on an input signal and provide as output an ML output indicative of a gain (e.g., the first gain).

The method 100 comprises executing S104, by a computer, multiple training rounds. Executing S104 each training round comprises determining S104A a training data set comprising a training audio signal and a target audio signal. Executing S104 each training round comprises applying S104B the training audio signal as input to a controller comprising the ML model for provision of an ML output based on the training audio signal. Executing S104 each training round comprises determining S104C a first gain based on the ML output. Executing S104 each training round comprises determining S104D a filter control signal based on the first gain. Executing S104 each training round comprises providing S104E the filter control signal to a time domain filter for filtering the training audio signal based on the filter control signal for provision of a training output signal. Executing S104 each training round comprises determining S104F an error signal based on the training output signal and the target audio signal. Executing S104 each training round comprises adjusting S104G weights, using a learning rule, of the machine learning model based on the error signal.

In one or more example methods, the method 100 comprises obtaining S102 an input signal. In one or more example methods, determining S104A the training data set comprises generating S104AA the target audio signal by applying S104AAA a time-domain filter to the input signal. In one or more example methods, determining S104A the training data set comprises generating S104AB the training audio signal based on the input signal and a noise sound signal.

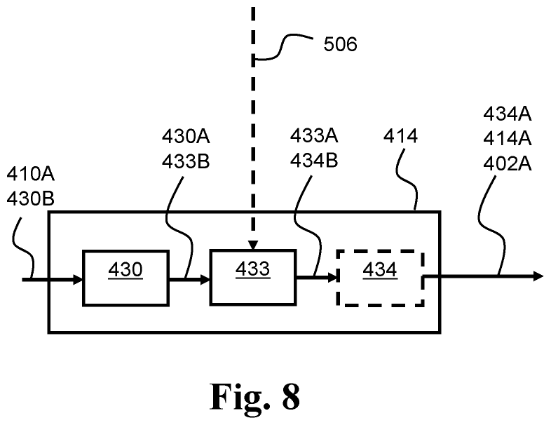

FIG. 8 schematically illustrates an example post-processor. The post-processor 414 comprises a booster 430 being a gain booster for provision of a booster output 430A based on ML output 410A, e.g. gain(s), as booster input 430B for the booster 430. The booster may boost the gains of the ML output 410A e.g. with 3 dB.

The post-processor 414 comprises a limiter 433 being a gain limiter for provision of a limiter output 433A based on booster output 430A fed as limiter input 433B to the limiter 433. The limiter 433 is a gain limiter configured to limit, e.g. upwards and/or downwards, the limiter input 433B, e.g. by applying one or more gain profiles to the limiter input 433B. The limiter 433 is optionally configured to apply a gain limit profile selected from a plurality of gain limit profiles, e.g. a first gain limit profile, a second gain limit profile and optionally a third gain limit profile, in accordance with a control signal 506 from processor 500 or a setting in the memory.

The limiter 433 is optionally configured to apply a first gain limit profile, e.g. in accordance with the control signal 506 being a first control signal or a first setting in the memory. The limiter 433 may be configured to apply a second gain limit profile, e.g. in accordance with the control signal 506 being a second control signal or a second setting in the memory. The limiter 433 may be configured to apply a third gain limit profile, e.g. in accordance with the control signal 506 being a third control signal or a third setting in the memory.

In one or more examples, the first gain profile has a first upper bound, e.g. of 0 dB, for all bands and/or a first lower bound, e.g. of −6 dB, for all bands. Accordingly, to apply a first gain limit profile in limiter 433 comprises to set gain(s) of the limiter output 433A to the first upper bound of 0 dB if the gain(s) in limiter input 433B is larger than the first upper bound 0 dB and/or to set gain(s) of the limiter output 433A to the first lower bound of −6 dB if the gain(s) in limiter input 433B is less than the first lower bound of −6 dB.

In one or more examples, the second gain profile has a second upper bound, e.g. of 0 dB, for all bands and/or a second lower bound, e.g. of −6 dB in the range from 3 to 10 bands and −12 dB for the remaining bands or in the range from 6 to 18 bands. Accordingly, to apply a second gain limit profile in limiter 433 comprises to set gain(s) of the limiter output 433A to the second upper bound of 0 dB if the gain(s) in limiter input 433B is larger than the second upper bound 0 dB and/or to set gain(s) of the limiter output 433A to the second lower bound of −6 dB or −12 dB if the respective gain(s) in limiter input 433B is less than the second lower bound of −6 dB or −12 dB.

In one or more examples, the third gain profile has a third upper bound, e.g. of 0 dB, for all bands and/or a third lower bound, e.g. of −9 dB in the range from 3 to 10 bands and −15 dB for the remaining bands or in the range from 6 to 18 bands. Accordingly, to apply a third gain limit profile in limiter 433 comprises to set gain(s) of the limiter output 433A to the third upper bound of 0 dB if the gain(s) in limiter input 433B is larger than the third upper bound 0 dB and/or to set gain(s) of the limiter output 433A to the third lower bound of −9 dB or −15 dB if the respective gain(s) in limiter input 433B is less than the third lower bound of −9 dB or −15 dB.

The post-processor 414 comprises a smoother 434 being a gain smoother for provision of a smoother output 434A optionally as post-processor output 414A and/or (first) gain 402A based on smoother input 434B, e.g. limiter output 434A as illustrated. The smoother 434 is configured to smooth gain(s) in the smoother input 434B, e.g. to remove, reduce, or dampen one or more intensity fluctuations associated with one or more of the ML output 410A, booster output 430A, and limiter output 433A, e.g. by determining whether the one or more intensity fluctuations of the smoother input 434B exceeds one or more second thresholds. The one or more intensity fluctuations may indicate one or more of a peak and a valley of a waveform (e.g., a frequency response) associated with the ML output/smoother input. Thus, to determine the first gain may comprise post-processing the ML output 410A for provision of a post-processor output 414A forming a first gain 402A.

Disclosed are hearing devices and methods according to any of the following items
Item 1. A hearing device comprising:
   an input module for provision of an input signal, the input module comprising one or more microphones including a first microphone for provision of a first microphone input signal, wherein the input signal is based on the first microphone input signal;
   a time domain filter for filtering the input signal for provision of a filter output signal;
   a processor for processing the filter output signal and providing an electrical output signal based on the filter output signal; and
   a receiver for converting the electrical output signal to an audio output signal,
   wherein the hearing device comprises a controller comprising a machine learning model for provision of an ML output based on the input signal, wherein the controller is configured to:
   determine a first gain based on the ML output;
   determine a filter control signal based on the first gain; and
   provide the filter control signal to the time domain filter for filtering the input signal based on the filter control signal.
Item 2. Hearing device according to Item 1, wherein the time domain filter comprises a warped finite impulse response filter.
Item 3. Hearing device according to any of Items 1-2, wherein the controller comprises a post-processor for processing the ML output, wherein the post-processor comprises one or more of a limiter and a smoother.
Item 4. Hearing device according to any of Items 1-3, wherein the input module comprises a beamformer for provision of a beamformer output, wherein the input signal is based on the beamformer output.
Item 5. Hearing device according to any of Items 1-4, wherein the controller is configured to determine one or more features including a first feature based on the input signal, and wherein the ML output is based on the first feature.
Item 6. Hearing device according to Item 5, wherein the controller is configured to determine the ML output by applying the machine learning model to the first feature.
Item 7. Hearing device according to Item 6, wherein the first feature comprises a power output.
Item 8. Hearing device according to any of Items 1-7, wherein the machine learning model comprises a deep neural network.
Item 9. Hearing device according to any of Items 1-8, wherein the ML output is one or more of: a gain, a signal-to-noise ratio, voice activity detection data, speaker recognition data, and a speech-to-signal mixture ratio.
Item 10. Hearing device according to any of Items 1-9, wherein the controller comprises a converter for converting the ML output to a gain.
Item 11. Hearing device according to any of Items 1-10, wherein the controller comprises a combiner for combining the first gain with a second gain for provision of a combined gain, and wherein to determine the filter control signal based on the first gain comprises to determine the filter control signal based on the combined gain.
Item 12. Hearing device according to any of Items 1-11, wherein to determine the filter control signal based on the first gain comprises to determine filter coefficients of the time domain filter and include the filter coefficients in the first control signal.
Item 13. Hearing device according to any of Items 1-12, the input module comprising a transceiver for provision of a transceiver input signal, wherein the input signal is based on the transceiver input signal.
Item 14. Hearing device according to any of Items 1-13, wherein the ML output is a gain comprising a vector of band-specific gains.
Item 15. Hearing device according to any of Items 1-14 as dependent on Item 3, wherein the ML output is a gain, and the post-processor comprises a gain booster for processing the ML output for provision of a booster output being a gain, and wherein to determine the first gain comprises to determine the first gain based on the booster output.
Item 16. Hearing device according to Item 15, wherein the limiter is a gain limiter for processing the booster output for provision of a limiter output being a gain, and wherein to determine the first gain comprises to determine the first gain based on the limiter output.
Item 17. Hearing device according to Item 16, wherein the smoother is a gain smoother processing the limiter output for provision of a smoother output being a gain, and wherein to determine the first gain comprises to determine the first gain based on the smoother output.
Item 18. A computer-implemented method for training a machine learning model to process as input an ML input based on an input signal and provide as output an ML output indicative of a gain, wherein the method comprises executing, by a computer, multiple training rounds, wherein each training round comprises:
   determining a training data set comprising a training audio signal and a target audio signal;
   applying the training audio signal as input to a controller comprising the machine learning model for provision of an ML output based on the training audio signal;
   determining a first gain based on the ML output;
   determining a filter control signal based on the first gain;
   providing the filter control signal to a time domain filter for filtering the training audio signal based on the filter control signal for provision of a training output signal;
   determining an error signal based on the training output signal and the target audio signal; and
   adjusting weights, using a learning rule, of the machine learning model based on the error signal.
Item 19. A computer-implemented method for training a machine learning model to process as input an ML input based on an input signal and provide as output an ML output indicative of a gain, wherein the method comprises executing, by a computer, multiple training rounds, wherein each training round comprises:
   determining a training data set comprising a training audio signal and a target gain;
   applying the training audio signal as input to a controller comprising the machine learning model for provision of an ML output based on the training audio signal;
   determining a first gain based on the ML output for provision of a training output signal;
   determining an error signal based on the training output signal and the target gain; and
   adjusting weights, using a learning rule, of the machine learning model based on the error signal.
Item 20. Method according to any Item 18, the method comprising obtaining an input signal, and wherein determining the training data set comprises generating the target audio signal by applying a time-domain filter to the input signal; and generating the training audio signal based on the input signal and a noise sound signal.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that the figures comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly, to be regarded in an illustrative rather than restrictive sense. The claimed invention is intended to cover all alternatives, modifications, and equivalents.

### LIST OF REFERENCES

2 Hearing device
4 Training component
200 Input module
200A Input signal
202 One or more microphones
202A First microphone
202AA First microphone input signal
202B Second microphone
202BA Second microphone input signal
203 Input combiner
203A Input combiner output signal
204 Beamformer
204A Beamformer output
206 Transceiver
206A Transceiver input signal
206C Training audio signal
300 Time-domain filter
300A Filter output signal
300B Training output signal
400 Controller
402 Analysis side branch block
402A Gain
404 Window function
404A First windowed signal block
404B Second windowed signal block
404C Third windowed signal block
404D Fourth windowed signal block
406 Fast Fourier transform (FFT) function
406A FFT signal
408 Feature extraction block
408A One or more features
408B First feature
410 Machine learning (ML) model
410A ML output
412 ML model module
414 Post-processor
414A Post-processor output
416 Converter
416A Converted ML output
418 Combiner
418A Combined gain
420 Filter design
420A Filter control signal
420AA First filter coefficient
420AB Second filter coefficient
420AC Third filter coefficient
420AD Fourth filter coefficient
422 Second gain determiner
422A Second gain
430 Booster
430A Booster output
430B Booster input
432 Converter
432A Filter control signal
432AA First filter coefficient
432AB Second filter coefficient
432AC Third filter coefficient
432AD Fourth filter coefficient
433 Limiter
433A Limiter output
433B Limiter input
434 Smoother
434A Smoother output
434B Smoother input
500 Processor
500A Electrical output signal
502 Structure of machine learning model
502A First gated recurrent (GRU) unit
502B Second gated recurrent (GRU) unit
502C Third gated recurrent (GRU) unit
504 Fully connected layer
506 Control signal from processor
600 Receiver
600A Audio output signal
600B Bias
601 Current input
602A Matrix
602B Bias
602C Weight matrix
604 Reset gate
604A Weight matrix
604B Bias
604C Weight matrix
606A Output of reset gate
606B Output of update gate
608 Update gate
608A Weight matrix
608B Bias
608C Weight matrix
610A Candidate hidden state
616 Previous hidden state
618 Current hidden state
700 First time-domain filter
700A Target audio signal
704 Element-wise multiplication
800 Error function
800A Error signal
800B Weights
100 Method of training a ML model
S102 Obtaining an input signal
S104 Executing multiple training rounds
S104A Determining a training data set comprising a training audio signal and a target audio signal
S104AA Generating the target audio signal
S104AAA Applying a time-domain filter to the input signal
S104AB Generating the training audio signal
S104B Applying the training audio signal as input to a controller comprising the ML model
S104C Determining a first gain
S104D Determining a filter control signal
S104E Providing the filter control signal to a time domain filter
S104F Determining an error signal
S104G Adjusting weights of the machine leaning model

1. A hearing device comprising:
an input module for provision of an input signal;
a time domain filter configured to perform filtering to provide a filter output signal based on the input signal;
a processor configured to provide an electrical output signal based on the filter output signal, the processor configured to compensate for hearing loss of a user of the hearing device;
a receiver configured to provide an audio output signal based on the electrical output signal; and
a controller comprising a machine learning model for provision of a model output based on the input signal, wherein the controller is configured to:
determine a first gain based on the model output;
determine a filter control signal based on the first gain; and
provide the filter control signal to the time domain filter for filtering the input signal based on the filter control signal.

2. The hearing device according to claim 1, wherein the time domain filter comprises a warped finite impulse response filter.

3. The hearing device according to claim 1, wherein the controller comprises a post-processor for processing the model output, wherein the post-processor comprises one or more of a limiter or a smoother.

4. The hearing device according to claim 1, wherein the input module comprises a beamformer for provision of a beamformer output, wherein the input signal is based on the beamformer output.

5. The hearing device according to claim 1, wherein the controller is configured to determine one or more features including a first feature based on the input signal, and wherein the model output is based on the first feature.

6. The hearing device according to claim 5, wherein the controller is configured to determine the model output by applying the machine learning model to the first feature.

7. The hearing device according to claim 6, wherein the first feature comprises a power output.

8. The hearing device according to claim 1, wherein the machine learning model comprises a deep neural network.

9. The hearing device according to claim 1, wherein the model output is one or more of: a gain, a signal-to-noise ratio, voice activity detection data, speaker recognition data, or a speech-to-signal mixture ratio.

10. The hearing device according to claim 1, wherein the controller comprises a converter for converting the model output to a gain.

11. The hearing device according to claim 1, wherein the controller comprises a combiner configured to combine the first gain with a second gain for provision of a combined gain, and wherein the filter control signal is based on the combined gain.

12. The hearing device according to claim 1, wherein the controller is configured to determine the filter control signal based on filter coefficients of the time domain filter.

13. The hearing device according to claim 1, wherein the controller is configured to include filter coefficients of the time domain filter in the filter control signal.

14. The hearing device according to claim 1, the input module comprising one or more microphones including a first microphone for provision of a first microphone input signal, wherein the input signal is based on the first microphone input signal

15. The hearing device according to claim 1, the input module comprising a transceiver for provision of a transceiver input signal, wherein the input signal is based on the transceiver input signal.

16. A computer-implemented method for training a machine learning model, the method comprising:
obtaining a training data set comprising a training audio signal and a target audio signal;
applying the training audio signal to a controller comprising the machine learning model for provision of a model output indicative of a gain based on the training audio signal;
determining a first gain based on the model output;
determining a filter control signal based on the first gain;
providing the filter control signal to a time domain filter for filtering the training audio signal based on the filter control signal for provision of a training output signal;
determining an error signal based on the training output signal and the target audio signal; and
adjusting weights of the machine learning model based on the error signal.

17. The method according to claim 16, further comprising obtaining an input signal, and wherein the act of obtaining the training data set comprises generating the target audio signal by applying a time-domain filter to the input signal, and generating the training audio signal based on the input signal and a noise sound signal.
